(19) United States
(12) Patent Application Publication
(10) Pub. No.: US 2005/0073906 A1
(43) Pub. Date: Apr. 7, 2005

(54) Screw for extruder, screw extruder, and kneading extruder using the screw extruder

(75) Inventor: Shinzo Hayashi, Obu-city (JP)

Correspondence Address: OLIFF & BERRIDGE, PLC, P.O. BOX 19928, ALEXANDRIA, VA, 22320, US

(73) Assignee: NGK INSULATORS, LTD., Nagoya-city (JP)

(21) Appl. No.: 10/919,430

(22) Filed: Aug. 17, 2004

(30) Foreign Application Priority Data
Aug. 21, 2003 (JP) 2003-297544

(51) Int. Cl. B29B 7/42; B29B 7/84

(52) U.S. Cl. 366/75; 366/90; 366/322

(57) ABSTRACT

A screw for an extruder includes a drive shaft and stirring blades arranged on the drive shaft, and blades among the stirring blades arranged at least part of the drive shaft adjacent to the leading edge of the drive shaft are interrupted blades, each of continuous surfaces of the interrupted blades being less than a full circle about the drive shaft. The screw is capable of effectively preventing problems that characteristics of a compressed material obtained are not unified in each part, resulting in uneven distribution, and discontinuous portions (screw marks) are formed inside the obtained compressed product.

### BACKGROUND OF THE INVENTION

1. Field of the Invention

The present invention relates to a screw extruder and a kneading extruder suitably used for manufacturing a ceramic green body, and in particular relates to a structure of a screw for an extruder.

2. Description of the Related Art

For example, as shown in FIG. 1, a screw extruder 1 has been proposed in that a screw 9 including a drive shaft 5 and stirring blades 7 arranged on the drive shaft 5 is arranged inside a hollow cylindrical barrel 3. (see Japanese Unexamined Patent Application Publication No. 9-94818 and No. 10-100131, for example).

A screw extruder 1 shown in FIG. 1 Includes a crew 9 having a spiral stirring blade 7a, which is continuously arranged on the surface of a drive shaft 5 so as to wind therearound as a stirring blade 7, and a plurality of sectoral stirring blades 7b. The screw extruder 1 may also be called as a kneader (auger machine) and has insufficient kneading functions. Its essential function is to compress a work material including powder with the screw 9 to be extruded as a high-density compressed product.

In the screw extruder shown in FIG. 1 when the drive shaft 5 is rotated by a driving force transmitted by the driving means (not shown, an electric motor, for example), a work material including powder thrown into the barrel 3 from a hopper (not shown) is extruded forward while being compressed by the stirring blades 7b and 7a of the screw 9, so that a high-density compressed product is continuously discharged in a cylindrical shape from a discharge outlet 11.

Such a screw extruder is suitably used for manufacturing a ceramic green body from a work material of a mixture of ceramic powder, a dispersion medium, and a binder, and in particular is suitably used for manufacturing an extrusion forming material for producing a porous honeycomb filter, such as a DPF (diesel particulate filter).

However, in the screw extruder as described above, there have been problems that characteristics (a density, an ingredient composition, a powder gain size, and moisture content, for example) of the obtained compressed product are disproportionated in each part resulting in uneven distribution, and as shown in FIG. 2B, a number of discontinuous portions (screw marks 13a) are formed inside the obtained compressed product 13.

When the ceramic green body obtained by the screw extruder mentioned above are used for the extrusion forming material for producing the porous honeycomb filter, the above-mentioned problems become especially obvious. Specifically, when the ceramic green body with not uniform density and uneven density distribution are used for the extrusion forming material, the porosity of the porous honeycomb filter, which is a final product, becomes heterogeneous, resulting in uneven distribution. That is, there has been a defect in that performances (mechanical strength and filter functions, etc.) of the porous honeycomb filter are adversely affected.

When the ceramic green body with a number of discontinuous portions (screw marks) formed inside is used for the extrusion forming material, since the screw mark portion is fragile (because of the density lower than that of other portions), inferior quality is caused, such as “tears” and large “pores” of the solid body or the porous honeycomb filter, which is a final product. Hence, there are problems that the porous honeycomb filter is liable to be damaged as well as a desired filter performance is difficult to be functioned.

### SUMMARY OF THE INVENTION

The present invention has been made in view of the problems of conventional techniques, and it is an object of the present invention to provide a screw for an extruder, a screw extruder, and a kneading extruder capable of effectively preventing problems that characteristics of the compressed material obtained are not unified in each part, resulting in uneven distribution, and discontinuous portions (screw marks) are formed inside the obtained compressed product.

By devoting oneself to the research for solving the above problems, the inventor has concluded to a result capable of solving these problems so as to make the present invention in that in a screw for an extruder, blades arranged on at least part of a drive shaft adjacent to the leading edge of the drive shaft among stirring blades are interrupted blades, each of continuous surfaces of the interrupted blades being less than a full circle about the drive shaft. The present invention provides a screw for an extruder, a screw extruder, and a kneading extruder as follows.

[1] A screw for an extruder including a drive shaft; and stirring blades arranged on the drive shaft, wherein the blades arranged on at least part of the drive shaft adjacent to the leading edge of the drive shaft among the stirring blades are interrupted blades, each of continuous surfaces of the interrupted blades being less than a full circle about the drive shaft.

[2] In the screw described in item [1], the interrupted blades may be arranged over at least 5% range of the length of the drive shaft from the leading edge of the drive shaft.

[3] In the screw described in item [1] or [2], the blades arranged on at least part of the drive shaft adjacent to the leading edge of the drive shaft among the stirring blades may be the interrupted blades, while a spiral continuous stirring blade may be arranged in the subsequent stage of the interrupted blades, a continuous surface of the continuous stirring blade being more than a full circle about the drive shaft.

[4] In the screw described in any one of items [1] to [3], the interrupted blade may be a single blade.

[5] In the screw described in any one of items [1] to [3], the interrupted blade may be a non-breakage portion that is a residual portion after breakage portions are intermittently formed on the continuous blade.

[6] A screw extruder including a hopper for throwing a work material including powder thereinto; a screw for compressing the thrown work material so as to be extruded; a hollow cylindrical barrel having the screw arranged therein; driving means for driving the screw; and a discharge outlet for discharging a compressed product of the work material compressed by the screw, wherein the screw includes the screw for the extruder described in any one of items [1] to [5].

[7] The screw extruder described in item [6] may be further provided with a vacuum chamber arranged between the hopper and the barrel and having a vacuum pressure reduction unit connected thereto for degassing the work material.

[8] A kneading extruder including a non-screw kneader; and the screw extruder described in item [6] or [7], wherein to the subsequent stage to the non-screw kneader, the screw extruder is connected, and the kneaded material kneaded by the non-screw kneader is thrown into the hopper of the screw extruder as the work material so that the kneading with the non-screw kneader and extruding with the screw extruder are continuously performed.

According to the screw for an extruder, the screw extruder, and the kneading extruder of the present invention, problems that characteristics of the compressed material obtained are not unified in each part, resulting in uneven distribution, and discontinuous portions (screw marks) are formed inside the obtained compressed product can be effectively prevented.

### BRIEF DESCRIPTION OF THE DRAWINGS

FIG. 1 is an explanation drawing of an example of a conventional screw extruder;

FIGS. 2A and 2B are explanation drawings showing sections of compressed products obtained from a screw extruder, FIG. 2A is an explanation drawing of a section of a compressed product obtained from a screw extruder according to the present invention, FIG. 2B is that from a conventional screw extruder;

FIG. 3 is an explanation drawing showing an embodiment of a screw extruder according to the present invention;

FIG. 4 is an explanation drawing showing another embodiment of the screw extruder according to the present invention;

FIG. 5 is an explanation drawing of an example of a screw extruder in Comparative Example 1; and

FIG. 6 is a graph showing distribution of density ρ of each part of ceramic green bodies obtained from screw extruders.

### DESCRIPTION OF THE PREFERRED EMBODIMENTS

Upon developing a screw for an extruder, a screw extruder, and a kneading extruder according to the present invention, the inventor first has been examined causes of the uneven distribution of product characteristics obtained from a conventional screw extruder, which results in discontinuous portions (screw marks) produced inside the product.

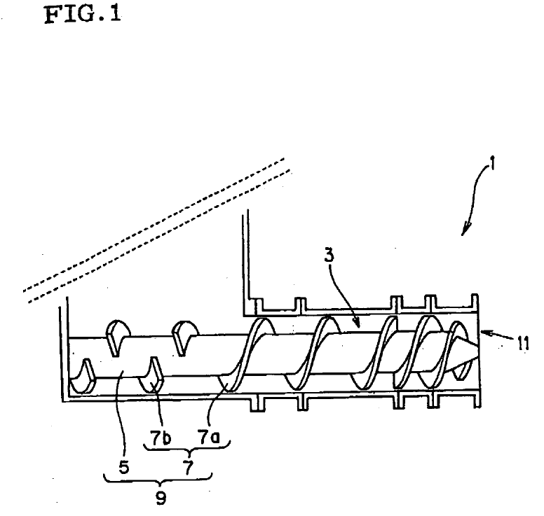

As a result in a conventional screw extruder 1 shown in FIG. 1, a spiral stirring blade 7a of the stirring blades 7 in the screw 9; (i) cannot uniformly apply a force (shearing force) to a work material structurally; (ii) causes the material to be discharged in a spirally deposited and compressed state along the shape of the spiral stirring blade 7a. Additionally, it has been proved that the spiral stirring blade 7a arranged adjacent to the leading edge of the screw 9 is a problem.

Specifically, as shown in FIG. 1, in the conventional screw extruder 1, a work material thrown into the barrel 3 from a hopper (not shown) is subjected to a shearing force from only around of the edge of the spiral stirring blade 7a while few force is applied from parts other than the edge, so that characteristics of the processed material obtained are not unified in each part, resulting in uneven distribution.

Also, a work material thrown into the barrel 3 from the hopper is extruded forward by the spiral stirring blade 7a in a substantially laminar-flow state along the spiral shape thereof. That is, since the processed material is discharged from an outlet 11 as a spirally deposited and compressed product along the shape of the spiral stirring blade 7a. discontinuous portions (screw marks) are formed inside the obtained compressed product.

Then, in a screw for an extruder according to the present invention, at least part of the stirring blade in the leading edge side is replaced with interrupted blades in that a continuous surface of the blade is less than a full circle about the drive shaft.

By replacing the stirring blade in the leading edge side of the drive shaft with the interrupted blades, the flow of the work material being extruded can become turbulent from the substantial laminar flow, so that the processed material can be kneaded in the vicinity of the outlet of the extruder (mixing effect). Hence, the problems that characteristics of the processed material obtained are not unified in each part, resulting in uneven distribution, and discontinuous portions (screw marks) are formed inside the obtained compressed product can be effectively prevented.

Embodiments of a screw for an extruder, a screw extruder and a kneading extruder according to the present invention will be specifically described below with reference to the drawings: however, a screw for an extruder, a screw extruder, and a kneading extruder according to the present invention are not limited to these embodiments.

(1) Screw for Extruder

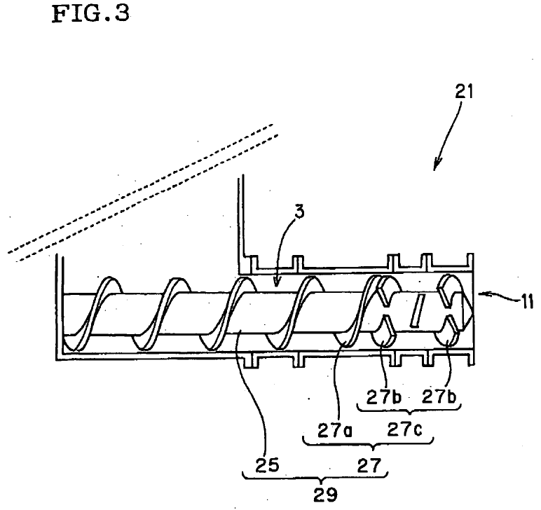

In general, a screw for an extruder includes a drive shaft and a stirring blade protruding from the drive shaft. Whereas, the screw for an extruder according to the present invention, like a screw 29 of a screw extruder 21 shown in FIG. 3, at least part of a stirring blade 27 in the leading edge side of a drive shaft 25 is made to be interrupted blades 27c in that a continuous surface of the blade is less than a full circle about the drive shaft.

The “interrupted blade” in this specification means a stirring blade with continuous surface of the blade being less than a full circle (i.e., less than 360°) about the drive shaft. Such an interrupted blade can change the work material being extruded at the interrupted portions (interstices) of the blades from the substantial laminar flow to a turbulent flow, so that the processed material can be kneaded in the vicinity of the outlet of the extruder (mixing effect).

The interrupted blades described above need to be arranged at least in part of the drive shaft adjacent to the leading edge thereof. In other words, at least the blade arranged in the vicinity of the leading edge of the drive shaft must be the interrupted blade. In the screw for the extruder according to the present invention, the processed material is essentially kneaded in the vicinity of the outlet of the extruder (mixing effect), thereby solving various problems caused by the spiral stirring screw.

As described above, in the screw for the extruder according to the present invention, the interrupted blades need to be arranged at least in part of the drive shaft adjacent to the leading edge thereof. More specifically, it is preferable that the interrupted blades be arranged over a range of at least 5% length of the drive shaft from the leading edge. It is much preferable that the interrupted blades be arranged over a range of at least 10% length; and it is still much preferable that the interrupted blades be arranged over a range of at least 20% length. If the range were less than the above ranges, the effect of kneading the work material (mixing effect) might not be undesirably obtained.

Furthermore, in the screw for the extruder according to the present invention, it is preferable that the interrupted blades be arranged at least in part of the drive shaft adjacent to the leading edge thereof while a continuous spiral blade in that a continuous surface of the blade is more than a full circle about the drive shaft be arranged along a subsequent stage of the drive shaft.

The “continuous blade” in this specification means a stirring blade with continuous surface of the blade being more than a full circle (i.e., more than 360°) about the drive shaft. Such a continuous blade is excellent in extruding the work material (extruding effect).

In the stirring blade of the screw for the extruder according to the present invention, as long as the blades arranged at least in a part of the drive shaft adjacent to the leading edge thereof are the interrupted blades, the arranging manner of the blade in other part of the drive shaft is not specifically limited, so that the interrupted blades may be arranged over a range of 100% length, i.e., the entire blade may be the interrupted blades. However, although the interrupted blade is excellent in kneading the work material (mixing effect), a thrust force for extruding the work material may not be obtained depending on the shape and arrangement thereof. Hence, it is preferable that the interrupted blades be arranged in the vicinity of the leading edge while the continuous spiral blade excellent In extruding the work material (extruding effect) be arranged along a subsequent stage thereof.

From such a view, it is preferable that the interrupted blades be arranged over a range of at most 70% length of the drive shaft from the leading edge while only the continuous spiral blade be arranged along the subsequent stage. It is much preferable that the interrupted blades be arranged over a range of at most 50% length while only the continuous spiral blade be arranged along the subsequent stage. If the range were more than the above ranges, the effect of extruding the work material (extruding effect) might not be undesirably obtained, so that the extruding thrust force may be diminished.

In addition, as described above, in the stirring blade of the screw for the extruder according to the present invention, as long as the blades arranged at least in a part of the drive shaft adjacent to the leading edge thereof are the interrupted blades, the arranging manner of the blade in other part of the drive shaft is not specifically limited, so that the entire blade arranged along the subsequent stage is not necessarily the continuous blade.

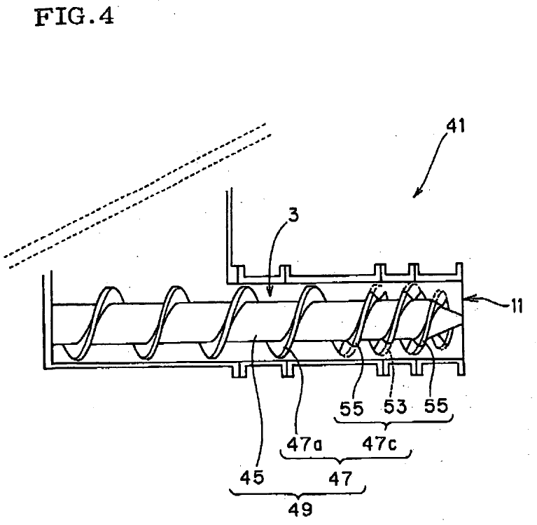

That is, a screw of an extruder according to the present invention incorporates screws 29 and 49 respectively shown in FIGS. 3 and 4, for example, in which interrupted blades 27c and 47c are arranged at least in part of the drive shaft from the leading edge while the entire blades other than the interrupted blades are continuous blades 27a and 47a, and also, a screw in that a continuous blade is arranged in the subsequent stage of interrupted blades arranged in at least part of the drive shaft from the leading edge and interrupted blades are also arranged further in the subsequent stage (not shown).

Although a manner of the interrupted blade is not specifically limited as long as a continuous surface of the blade is less than a full circle about the drive shaft, it is preferable that the interrupted blade be a single blade 27b like the interrupted blade 27c shown in FIG. 3.

The shape of the single blade is not specifically limited, so that in addition to the sectoral single blade 27b shown in FIG. 3, various shapes, such as a triangle, a square, and a rectangle, may be incorporated. In addition, part of such a shape may be embedded in the drive shaft.

Although, the arranging manner of the single blade 27b is not specifically limited, it is preferable that a blade surface be inclined to a plane perpendicular to a drive shaft 25 at a predetermined angle, like the single blade 27b shown in FIG. 3. It is much preferable that the two single blades 27b be arranged at predetermined positions about the drive shaft 25 so that planes including respective blade surfaces of two single blades 27b intersect each other (i.e., so that the two single blades 27b are inclined oppositely to each other).

The above arranging manner has the same extruding advantage as that of the case where the continuous blade is arranged in comparison with cases where the blade surface of the single blade 27b is included on a plane perpendicular to a drive shaft 5 and where the two single blades 27b are inclined In the same direction.

With regard to the number of the single blades 27b, the number of about one to ten is preferable; the number of about two to six is much preferable; and the number of about two to four is especially preferable. If the range were less than the above ranges, the effect of kneading the work material (mixing effect) by the interrupted blade (the single blade in this case) might not be undesirably obtained, while if the range were more than the above ranges, the effect of extruding the work material (extruding effect) might not be undesirably obtained, so that the extruding thrust force may not be maintained.

As the arranging manner of the interrupted blade, like the interrupted blades 47c of the screw 49 of a screw extruder 41 shown in FIG. 4, non-breakage portions 55 of the continuous blade providing with breakage portions 53 intermittently formed therein may also be suitably used.

The interrupted blade 47c may be produced by such a method of forming the breakage portion 53 by cutting off part of the continuous blade. The shape of the breakage portion 53 is not specifically limited; there may be a sectoral shape like the interrupted blade 47c shown in FIG. 4.

It is preferable that an area ratio between the non-breakage portion 55 and the breakage portion 53 in the interrupted blades 47c be within a range of 95:5 to 20:80; much preferable be within a range of 90:10 to 40:60; and especially preferable be within a range of 80:20 to 50:50. If the range were out of the above ranges, the effect of kneading the work material (mixing effect) might not be obtained so as not to solve various problems due to a spiral stirring blade.

(2) Screw Extruder

A screw extruder according to the present invention includes the screw for the extruder according to the present invention described in the item (1) for compressing and extruding a work material thrown thereinto. Such a screw extruder has an effect (mixing effect) kneading the work material in the vicinity of a discharge outlet. Hence, problems that characteristics of the processed material obtained are not unified in each part, resulting in uneven distribution and discontinuous portions (screw marks) are formed inside the obtained compressed product can be effectively prevented.

The screw extruder according to the present invention may be structured In the same way as in a conventional known screw extruder except for the screw for the extruder according to the present invention for compressing and extruding a work material thrown thereinto described in the item (1).

Specifically, it is sufficient that the screw extruder includes a hopper for throwing a work material including power thereinto, a screw for compressing and extruding the thrown work material, a hollow cylindrical barrel for arranging the screw inside, driving means for rotating the screw, and a discharge outlet for discharging the compressed product. With such a screw extruder, a work material thrown from the hopper is compressed and extruded by the screw rotated by the driving means inside the barrel, and discharged from the discharge outlet as a high-density compressed product.

The component elements of the screw extruder described above are not specifically limited in shape, structure, and material as long as the functions are guaranteed; however, a motor is generally used for the driving means.

It is preferable that the screw extruder according to the present invention be provided with a vacuum chamber arranged between the hopper and the barrel and having a vacuum pressure reduction unit connected thereto for degassing the work material. By having such a structure, the sufficiently degassed work material is supplied to the barrel, so that a compressed product with small defects and excellent formability can be obtained. As the vacuum pressure reduction unit, a vacuum pump is suitably used, for example.

(3) Kneading Extruder

A kneading extruder according to the present invention includes a non-screw kneader and the screw extruder described in the item (2), in which to the subsequent stage of the non-screw kneader, the screw extruder described in the item (2) is connected. The kneaded material kneaded by the non-screw kneader is thrown into the hopper of the screw extruder described in the item (2), so that the kneading with the non-screw kneader and extruding with the screw extruder described in the item (2) are continuously performed.

The screw extruder according to the present invention has the effect of kneading the work material (mixing effect) by arranging the interrupted blades at the leading edge of the drive shaft, so that the problems that characteristics of the compressed material obtained are not unified In each part, resulting in uneven distribution, and discontinuous portions (screw marks) are formed inside the obtained compressed product can be effectively prevented. However, when an extrusion-forming material of a high-functional ceramic product demanding strict uniformity of the material is produced, it is much preferable that a kneaded material kneaded in advance with the non-screw kneader having the high kneading effect be thrown into the screw extruder according to the present invention as a work material. The compressed product obtained by such a manner can have the characteristics more unified in each part.

In the kneading extruder according to the present invention, to the subsequent stage of the non-screw kneader, the screw extruder described in the item (2) is connected. By having such a structure, kneading with the non-screw kneader and extruding with the screw extruder described in the item (2) can be continuously performed.

The non-screw kneader used in the kneading extruder according to the present invention may suitably include a conventional known kneader, such as a kneader, a Warner mixer, a kneading roller, and a Banbury mixer.

### EXAMPLE

The present invention will be described more specifically with examples below; however, the present invention is no longer limited to these examples. The average particle diameter of an aggregate particle material used in the examples and the comparative examples below used the 50% particle diameter value measured by an X-ray translucent grain-size distribution measurement device (Sedigraph type 5000-02 from Shimadzu Corporation, for example) using a liquid-phase sedimentation method as a measuring principle.

### (COMPARATIVE EXAMPLE 1, EXAMPLE 1)

As an aggregate particle material, a cordierited material was prepared by mixing talc (an average particle diameter of 20 μm) 41.6 mass percent, kaolin(an average particle diameter of 10 μm) 10.1 mass percent, aluminum hydroxide (an average particle diameter of 1 μm) 24.5 mass percent, and silica (an average particle diameter of 20 μm) 13.7 mass percent.

To the aggregate particle material 100 mass part, methyl cellulose 5 mass part as an organic binder, potassium lauric acid 0.1 mass part as dispersant (detergent), and water 20 mass part as a disperse medium were added. Furthermore, to the aggregate particle material 100 volume part, microcapsules (acrylic acid microcapsules) 30 volume part made of an expanded resin were added so as to prepare a work material.

### COMPARATIVE EXAMPLE

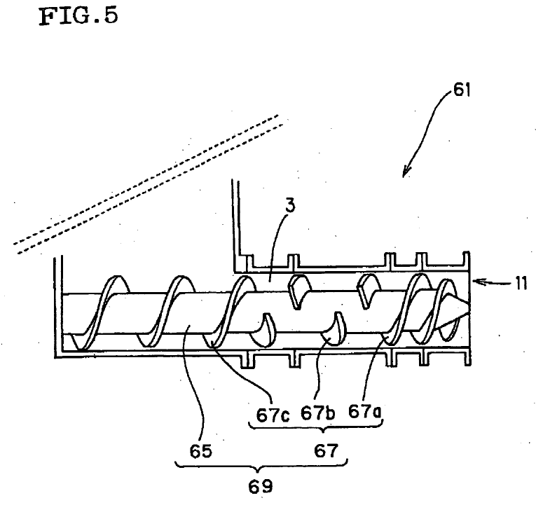

The above-mentioned work material was compressed with a screw extruder 61 shown in FIG. 5. The screw extruder 61 included a crew 69 having spiral stirring blades 67a and 67c, which are continuously arranged on the surface of a drive shaft so as to wind therearound as a stirring blade 67, and a plurality of sectoral stirring blades 67b.

The spiral stirring blade 67a was arranged adjacent to the leading edge of the drive shaft 65. The continuous blade surface of the stirring blade 67a was 2.5 circles about the drive shaft 65, and the helix of the blade surface was inclined at an angle of 16° to a plane perpendicular to the drive shaft 65. The stirring blade 67a was arranged over a 20% range of the drive shaft 65 from the leading edge, and the height thereof was 40 mm from the surface of the drive shaft 65.

In the subsequent stage of the spiral stirring blade 67a, a plurality of sectoral stirring blades 67b were arranged as interrupted blades. The shape of the stirring blade 67b was a sector with a central angle of 40°, and the height thereof was 40 mm from the surface of the drive shaft 65. The arranging manner was: the two stirring blades 67b were arranged at positions of symmetry about the drive shaft 65, respectively; and the two stirring blades 67b were arranged so that planes including blade surfaces intersect to each other (i.e., the blade surfaces of the two stirring blades 67b were inclined at an angle of 16° to a plane normal to the drive shaft 65 in directions opposite to each other). The number of the arranged stirring blades 67b was four.

Furthermore, in the subsequent stage of the stirring blades 67b, a spiral stirring blade 67c was arranged. Regarding to the helix angle of the spiral stirring blade 67c, in the same way as in the stirring blade 67a, the blade surface was inclined at an angle of 16° to a plane normal to the drive shaft 65.

The screw extruder 61 in Comparative Example 1 included a hopper (not shown ) for throwing a work material including powder thereinto, the screw 69 (mentioned above) for compressing and extruding the thrown work material, a hollow cylindrical barrel 63 having the screw 69 arranged therein, driving means (not shown) for driving the screw 69, and the discharge outlet 11 for discharging the work material compressed by the screw 69. The barrel 63 was a cylinder with an inner diameter of 200 mmφ and a length of 600 mm, and an electric motor was used for the driving means.

The screw extruder 61 in Comparative Example 1 was further provided with a vacuum chamber arranged between the hopper (not shown) and the barrel 63 and having a vacuum pressure reduction unit connected thereto for degassing the work material. As the vacuum pressure reduction unit, a vacuum pump was used.

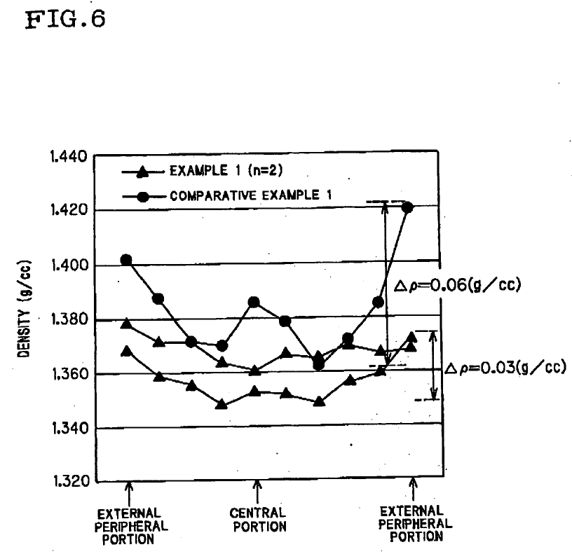

Using the screw extruder 61, compression was performed under a vacuum of 1 kPa and at a drive shaft rotational speed of 5 rpm so as to obtain a compressed product (ceramic green body) having a cylindrical shape with an outer diameter of 200 mmφ and a length of 500 mm. By cutting the compressed product along a plane including the central axis, the cut surface was observed. Measurement samples were taken from ten positions of external peripheral portions, central portions, and other external peripheral portions of the compressed product in that order so as to measure densities. The results are shown in FIG. 6.

### EXAMPLE 1

The work material mentioned above was compressed with the screw extruder 21 shown in FIG. 3. The screw extruder 21 included the screw 29 having the interrupted blades 27c and the continuous blade 27a as the stirring blade 27. The interrupted blades 27c were arranged over 20% range of the length of the drive shaft 25 from the leading edge.

The sectoral single blades 27b were arranged adjacent to the leading edge of the drive shaft 25 as the interrupted blades 27c. The shape of the single blade 27b was a sector with a central angle of 40°, and the height thereof was 40 mm from the surface of the drive shaft 25. The arranging manner of the single blade 27b was the two single blades 27b were arranged at positions of symmetry about the drive shaft 25, respectively; and the two single blades 27b were arranged so that planes including blade surfaces intersect to each other (i.e., the blade surfaces of the two single blades 27b were inclined at an angle of 16° to a plane normal to the drive shaft 25 in directions opposite to each other) The number of the arranged single blades 27b was four.

In the subsequent stage of the interrupted blades 27c, the spiral continuous blade 27a was arranged. The continuous blade surface was 4.5 circles about the drive shaft, and the helix of the blade surface was inclined at an angle of 16° to a plane perpendicular to the drive shaft 25. The height of the blade was 40 mm from the surface of the drive shaft 25. In Example 1, the entire stirring blade 27 other than the Interrupted blades 27c arranged adjacent to the leading edge of the drive shaft 25 was the continuous blade 27a.

The screw extruder 21 in Example 1 was structured in the same way as in a conventional known screw extruder except for the above-mentioned screw 29 used for compressing and extruding a work material thrown thereinto.

That is, the screw extruder 21 included a hopper (not shown) for throwing a work material including powder thereinto, the screw 29 (mentioned above) for compressing and extruding the thrown work material, the hollow cylindrical barrel 3 having the screw 29 arranged therein, driving means (not shown) for driving the screw 29, and the discharge outlet 11 for discharging the work material compressed by the screw 29. The barrel 3 was a cylinder with an inner diameter of 200 mmφ and a length of 600 mm, and an electric motor was used for the driving means.

The screw extruder 21 in Example 1 was further provided with a vacuum chamber arranged between the hopper (not shown) and the barrel 3 and having a vacuum pressure reduction unit connected thereto for degassing the work material. As the vacuum pressure reduction unit, a vacuum pump was used.

Using the screw extruder 21, compression was performed under a vacuum of 1 kPa and at a drive shaft rotational speed of 5 rpm so as to obtain a compressed product (ceramic green body) having a cylindrical shape with an outer diameter of 200 mmφ and a length of 500 mm. By cutting the compressed product along a plane including the central axis, the cut surface was observed. Measurement samples were taken from ten positions of external peripheral portions, central portions, and other external peripheral portions of the compressed product in that order so as to measure densities. The results are shown in FIG. 6.

[Evaluated Results]

As is apparent from the graph in FIG. 6, the compressed product (ceramic green body) was uneven in density with scattered density distribution. Hence, when this compressed product was used for an extrusion forming material for producing a porous honeycomb filter, it was anticipated that the porosity of the porous honeycomb filter obtained finally become heterogeneous, resulting in uneven distribution.

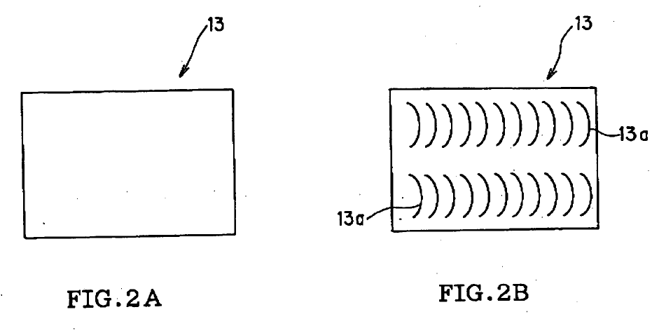

When a section of the compressed product was observed, as shown in FIG. 2B, a number of rib-shaped screw marks 13a were recognized. The compressed product 13 having the screw marks 13a formed in such a manner was easily detached because the screw mark portion 13a was fragile. Hence, when the compressed product was used for the extrusion forming material for producing the porous honeycomb filter, it was anticipated that inferior quality be caused, such as “tears” and large “pores” of the solid body or the porous honeycomb filter, which is a final product, so that there were problems that the porous honeycomb filter was liable to be damaged as well as a desired filter performance was difficult to be functioned.

On the other hand. the compressed product (ceramic green body) had uniform density with substantially even density distribution. Specifically, the difference (Δp) between the maximum density and the minimum density was half of that of the compressed product (ceramic green body) obtained with the screw extruder in Comparative Example 1. Hence, even when the compressed product was used for the extrusion forming material for producing the porous honeycomb filter, it was anticipated that the porous honeycomb filter be produced with the porosity unified with substantially even density distribution.

When a section of the compressed product was observed, as shown in FIG. 2A, the screw mark was not entirely recognized. That is, since such a compressed product 13 had not a fragile portion, such as a screw mark, even when the compressed product was used for the extrusion forming material for producing the porous honeycomb filter, it was anticipated that inferior quality was not caused, such as “tears” and large “pores” of the solid body or the porous honeycomb filter, which is a final product, so that there were no problems that the porous honeycomb filter was liable to be damaged as well as a desired filter performance was difficult to be functioned.

As described above, according to the screw for an extruder, the screw extruder, and the kneading extruder of the present invention, problems that characteristics of the compressed material obtained are not unified in each part, resulting in uneven distribution, and discontinuous portions (screw marks) are formed inside the obtained compressed product can be effectively prevented. Hence, these devices can be suitably used for manufacturing a ceramic green body from a work material of a mixture of ceramic powder, a dispersion medium, and a binder, and in particular is suitably used for manufacturing an extrusion forming material for producing a porous honeycomb filter, such as a diesel particulate filter (DPF).

1. A screw for an extruder comprising:
a drive shaft; and
stirring blades arranged on the drive shaft,
wherein the blades arranged on at least part of the drive shaft adjacent to the leading edge of the drive shaft among the stirring blades are interrupted blades, each of continuous surfaces of the interrupted blades being less than a full circle about the drive shaft.

2. The screw according to claim 1, wherein the interrupted blades are arranged over at least 5% range of the length of the drive shaft from the leading edge of the drive shaft.

3. The screw according to claim 1, wherein the blades arranged on at least part of the drive shaft adjacent to the leading edge of the drive shaft among the stirring blades are the interrupted blades, while a spiral continuous stirring blade is arranged in the subsequent stage of the interrupted blades, a continuous surface of the continuous stirring blade being more than a full circle about the drive shaft.

4. The screw according to claim 1, wherein the interrupted blade comprises a single blade.

5. The screw according to claim 1, wherein the interrupted blade is a non-breakage portion that is a residual portion after breakage portions are intermittently formed on the continuous blade.

6. A screw extruder comprising:
a hopper for throwing a work material including powder thereinto;
a screw for compressing the thrown work material so as to be extruded;
a hollow cylindrical barrel having the screw arranged therein;
driving means for driving the screw; and
a discharge outlet for discharging a compressed product of the work material compressed by the screw,
wherein the screw is a screw for an extruder comprising a drive shaft and stirring blades arranged on the drive shaft, the blades arranged on at least part of the drive shaft adjacent to the leading edge of the drive shaft among the stirring blades being interrupted blades, each of continuous surfaces of the interrupted blades being less than a full circle about the drive shaft.

7. The screw extruder according to claim 6, wherein the interrupted blades are arranged over at least 5% range of the length of the drive shaft from the leading edge of the drive shaft.

8. The screw extruder according to claim 6, wherein the blades arranged on at least part of the drive shaft adjacent to the leading edge of the drive shaft among the stirring blades are the interrupted blades, while a spiral continuous stirring blade is arranged in the subsequent stage of the interrupted blades, a continuous surface of the continuous stirring blade being more than a full circle about the drive shaft.

9. The screw extruder according to claim 6, wherein the interrupted blade comprises a single blade.

10. The screw extruder according to claim 6, wherein the interrupted blade is a non-breakage portion that is a residual portion after breakage portions are intermittently formed on the continuous blade.

11. The screw extruder according to claim 6, further comprising a vacuum chamber arranged between the hopper and the barrel and having a vacuum pressure reduction unit connected thereto for degassing the work material.

12. The screw extruder according to claim 7, further comprising a vacuum chamber arranged between the hopper and the barrel and having a vacuum pressure reduction unit connected thereto for degassing-the work material.

13. The screw extruder according to claim 8. further comprising a vacuum chamber arranged between the hopper and the barrel and having a vacuum pressure reduction unit connected thereto for degassing the work material.

14. The screw extruder according to claim 9, further comprising a vacuum chamber arranged between the hopper and the barrel and having a vacuum pressure reduction unit connected thereto for degassing the work material.

15. The screw extruder according to claim 10, further comprising a vacuum chamber arranged between the hopper and the barrel and having, a vacuum pressure reduction unit connected thereto for degassing the work material.

16. A kneading extruder comprising:
a non-screw kneader; and
the screw extruder including a hopper for throwing a work material including powder thereinto, a screw for compressing the thrown work material so as to be extruded, a hollow cylindrical barrel having the screw arranged therein, driving means for driving the screw, and a discharge outlet for discharging a compressed product of the work material compressed by the screw, wherein the screw is a screw for an extruder comprising a drive shaft and stirring blades arranged on the drive shaft, the blades arranged on at least part of the drive shaft adjacent to the leading edge of the drive shaft among the stirring blades being interrupted blades, each of continuous surfaces of the interrupted blades being less than a full circle about the drive shaft,
wherein to the subsequent stage to the non-screw kneader, the screw extruder is connected, and the kneaded material kneaded by the non-screw kneader is thrown into the hopper of the screw extruder as the work material so that the kneading with the non-screw kneader and extruding with the screw extruder are continuously performed.

17. The kneading extruder according to claim 16, further comprising a vacuum chamber arranged between the hopper and the barrel and, having a vacuum pressure reduction unit connected thereto for degassing the work material.
